(19) United States
(12) Patent Application Publication
(10) Pub. No.: US 2018/0161679 A1
(43) Pub. Date: Jun. 14, 2018

(54) DEVICE, METHOD, AND COMPUTER PROGRAM FOR PROVIDING GAME SERVICE

(71) Applicant: VISUALSHOWER CORP., Gangnam-gu, Seoul (KR)

(72) Inventor: Hong Kwan PARK, Mapo-gu (KR)

(21) Appl. No.: 15/579,870

(22) PCT Filed: Jun. 7, 2016
(86) PCT No.: PCT/KR2016/005972

§ 371 Date: Dec. 5, 2017

(30) Foreign Application Priority Data
Jun. 5, 2015 (KR) 10-2015-0080034

(51) Int. Cl. A63F 13/792; A63F 13/65; G06Q 20/38; A63F 13/20

(52) U.S. Cl. CPC A63F 13/792; A63F 13/20; G06Q 20/385; A63F 13/65

(57) ABSTRACT

A device, a method, and a computer program for providing a game service. The game service providing device includes a communicator that receives at least one of payment code readout information of an item card and a first card readout information of the item card, an account manager that generates a card account corresponding to the item card on the basis of the payment code readout information, and updates the card account based on the first card readout information, and a database that stores information about the card account.

### CROSS REFERENCE TO RELATED APPLICATIONS

This application is the National Stage of International Application No. PCT/KR2016/005972, having an International Filing Date of 7 Jun. 2016, which designated the United States of America, and which International Application was published under PCT Article 21 (2) as WO Publication No. 2016/195445A1, and which claims priority from and the benefit of Korean Application No. 10-2015-0080034, filed on 5 Jun. 2015, the disclosures of which are incorporated herein by reference in their entirety.

### BACKGROUND

### 1. Field

Aspects of the presently disclosed embodiment relate to a device, a method, and a computer program for providing a game service.

### 2. Brief Description of Related Developments

Online game items are tools that exist on games in various ways so as to add pleasure to users enjoying games through the Internet by wire or by wireless.

Such items are traded online and are traded offline in the form of cards, toys, and the like. Various methods of acquiring items traded in the form of cards, toys, and the like on online games are being developed.

### SUMMARY

Aspects of the presently disclosed embodiment provide a device, a method, and a computer program f or providing a game service.

A game service providing device according to an aspect of the presently disclosed embodiment includes a communicator that receives at least one of payment code readout information of an item card and first card readout information of the item card, an account manager that generates a card account corresponding to the item card based on the payment code readout information and updates the card account based on the first card readout information, and a database that stores information about the card account.

According to aspects of the presently disclosed embodiment, a device, a method, and a computer program for providing a game service can be provided.

### BRIEF DESCRIPTION OF THE DRAWINGS

FIG. 1 is a block diagram schematically illustrating a game service providing device according to an aspect of the presently disclosed embodiment.

FIG. 2 is a diagram for describing a relationship between a card, a payment code reader, and a game service providing device, according to an aspect of the presently disclosed embodiment.

FIG. 3 is a diagram schematically illustrating a configuration of a card according to an aspect of the presently disclosed embodiment.

FIG. 4 is a flowchart schematically describing a card activating method for providing a game service, according to another aspect of the presently disclosed embodiment.

FIGS. 5a and 5b are diagrams for describing a card account and a user account generated by a game service providing device, according to an aspect of the presently disclosed embodiment.

FIG. 6 is a diagram for describing a relationship between a card, a card reader, a terminal, and a game service providing device, according to an aspect of the presently disclosed embodiment.

FIG. 7 is a block diagram schematically illustrating a terminal according to an aspect of the presently disclosed embodiment.

FIG. 8 is a flowchart schematically describing a game service providing method according to an aspect of the presently disclosed embodiment.

FIGS. 9a and 9b are diagrams for describing a card account and a user account updated by a game service providing device, according to an aspect of the presently disclosed embodiment.

FIG. 10 is a flowchart schematically describing a game service providing method according to another aspect of the presently disclosed embodiment.

FIGS. 11a and 11b are diagrams for describing a card account and a user account updated by a game service providing device, according to another aspect of the presently disclosed embodiment.

FIG. 12 is a flowchart schematically describing a game service providing method according to another aspect of the presently disclosed embodiment.

FIGS. 13a and 13b are diagrams for describing a card account and a user account updated by a game service providing device, according to another aspect of the presently disclosed embodiment.

FIG. 14 is a flowchart schematically describing a game service providing method according to another aspect of the presently disclosed embodiment.

FIGS. 15a and 15b are diagrams for describing a card account and a user account updated by a game service providing device, according to another aspect of the presently disclosed embodiment.

### DETAILED DESCRIPTION

The advantages and features of the presently disclosed embodiment and methods for achieving the same will become apparent from the following aspects that are described in detail in conjunction with the accompanying drawings. However, it should be understood that these aspects are not construed as limited to the illustrated forms and include all changes, equivalents, or alternatives within the idea and the technical scope of the presently disclosed embodiment. The following aspects are provided so that this disclosure will be thorough and complete, and will fully convey the scope of the disclosed embodiment to those skilled in the art. In the following descriptions, descriptions of well-known functions and constructions will be omitted if they are considered to unnecessarily obscure the gist of the presently disclosed embodiment.

The terminology used herein is for the purpose of describing particular aspects only and is not intended to limit the scope of the presently disclosed embodiment. As used herein, the singular forms “a”, “an”, and “the” are intended to include the plural forms as well, unless the context clearly indicates otherwise. It will be understood that terms such as “comprise”, “include”, and “have”, when used herein, specify the presence of stated features, integers, steps, operations, elements, components, or combinations thereof, but do not preclude the presence or addition of one or more other features, integers, steps, operations, elements, components, or combinations thereof. It will be understood that although the terms “first”, “second”, etc. may be used herein to describe various components, these components should not be limited by these terms. These components are only used to distinguish one component from another.

The terms “communication”, “communication network”, “Internet network”, and “network” used herein may be used as the same meaning. The above terms mean a wired or wireless local and wide area data transmission and reception network that enables files to be transmitted and received between a user terminal, terminals of other users, and a download server.

In the present specification, when one component “transmits” data to another component, it means that the component may transmit the data directly to the other component, or may transmit the data to the other component through at least one other component.

In contrast, when one component “directly transmits” data to another component, it means that the data is transmitted to the other component without passing through another component.

The terms “unit” and “module” used herein may mean a functional and structural combination of hardware for performing the technical spirit of the presently disclosed embodiment and software for driving the hardware. For example, the term “module” may mean a logical unit of predetermined codes and hardware resources for performing the predetermined codes, and it will be apparent to those skilled in the art that the module is not limited to physically connected codes or one type of hardware.

Hereinafter, aspects of the presently disclosed embodiment will be described in detail with reference to the accompanying drawings, and in the drawings, like reference numerals denote like elements, and a redundant explanation thereof will not be provided herein.

FIG. 1 is a block diagram schematically illustrating a game service providing device according to an aspect of the presently disclosed embodiment.

Referring to FIG. 1, the game service providing device 10 according to the aspect of the presently disclosed embodiment includes a communicator 11, an account manager 12, and a database 13.

The communicator 11 receives payment code readout information of an item card.

The payment code readout information may include transaction information such as transaction identification information, affiliate code, product information, and transaction amount.

The transaction identification information is a unique transaction number generated when an approval request for transaction is made to a financial server. The transaction identification information is used for transaction inquiry or error tracking and is needed to cancel the transaction.

The affiliate code is a combination of alphabets and/or numbers assigned to the affiliate and is used to distinguish an affiliate at the time of transaction processing.

The product information is a code for identifying a product, and one piece of payment code readout information may include product information about one item card or product information about one item card bundle. The product information about one item card bundle may include a plurality of pieces of product information corresponding to a plurality of item cards included in one item card bundle, but is not limited thereto.

The communicator 11 receives card readout information of the item card.

The card readout information may include card information, item information, and/or user identification information.

The card information may include card identification information identifying the card, and the item information may include item identification information identifying the item included in the item card. The user identification information may include information identifying a user recognized by a card reader that has generated the card readout information.

The communicator 11 transmits at least one of card account generation notification, item display information, and item deletion display information.

For example, the communicator 11 may transmit a card account generation notification corresponding to payment code readout information to a payment code reader that has generated and transmitted the payment code readout information.

As another example, the communicator 11 may transmit item display information or item deletion display information corresponding to card readout information to a terminal that has generated and transmitted the card readout information.

The account manager 12 generates a card account corresponding to the item card based on payment code readout information received through the communicator 11. For example, the account manager 12 may generate a card account corresponding to one item card based on payment code readout information including product information for one item card. As another example, the account manager 12 may generate a plurality of card accounts corresponding to a plurality of item cards included in the item card bundle, based on payment code readout information including product information for one item card bundle.

The account manager 12 may generate the card account by generating a field that stores information about the card account in the database 13 to foe described below. The field may mean a predetermined data storage designation region in a storage region of the database 13.

The information about the card account may include at least one of card identification information identifying the item card, card binding information indicating an owner of the item card, item identification information identifying the item included in the item card, and item use history information indicating the use history of the item online.

According to an aspect, the account manager 12 may generate a card information field including at least one of a card identification information field and a card binding information field in the database 13. In this case, the account manager 12 may store card identification information in the card identification information field or store default information in the card binding information field, based on the payment code readout information received through the communicator 11.

According to another aspect, the account manager 12 may generate an item information field including at least one of a item identification information field and a item use history information field in the database 13. In this case, the account manager 12 may store item identification information in the item identification information field or store default information in the item use history information field, based on the payment code readout information received through the communicator 11.

The account manager 12 updates the card account based on the card readout information. The card readout information may include at least one of card identification information and user identification information recognized by the card reader that has generated the card readout information. The user identification information may be information identifying a user who uses the game service providing device according to the aspect of the presently disclosed embodiment. The card reader may be connected to the terminal or may be provided in the terminal and recognize information identifying a user who accesses the game service providing apparatus that is being executed in the corresponding terminal or has been executed in the corresponding terminal.

The account manager 12 may update the card account by storing user identification information in the card binding information field based on the card readout information.

According to an aspect, the account manager 12 may store the user identification information in the card binding information field based on one piece of card readout information. When another piece of card readout information including the same card identification information and user identification information as the card identification information and user identification information included in the one piece of card readout information is received through the communicator 11, the account manager 12 may delete the user identification information from the card binding information field based on the another piece of card readout information.

According to another aspect, the account manager 12 may store the user identification information in the card binding information field based on one piece of card readout information. When another piece of card readout information including different user identification information from the user identification information included in the one piece of card readout information is received through the communicator 11, the account manager 12 may maintain the user identification information stored in the card binding information field, without deleting the user identification information, even if the same card identification information as the one piece of card readout information is included in the another piece of card readout information.

According another aspect, the account manager 12 may store item identification information in the item identification information field or store item one-time use information in the item use history information field, based on the card readout information.

According another aspect, the account manager 12 may store item identification information in the item identification information field or store default information in the item use history information field, based on the card readout information. Then, when an item execution input for using the item included in the item card online is received through the communicator 11, the account manager 12 may store item one-time use information in the item use history information field, based on the item execution input.

When the account manager 12 stores the item one-time use information in the item use history information field, the account manager 12 may generate item display information.

When the account manager 12 deletes the user identification information from the card binding information field, the account manager 12 may generate item deletion display information.

The account manager 12 may accumulatively store the number of times of use of the item in the card account by storing item multiple-times use information in the item use history information field based on a plurality of pieces of card readout information each including the same card identification information.

The account manager 12 may generate a user account corresponding to a user receiving a game service, and update the user account based on the card readout information.

The account manager 12 may generate the user account by generating a field that stores information about the user account in the database 13.

The information about the user account may include at least one of user identification information identifying the user, card binding information indicating an item card owned by the user, and item use history information indicating the use history of the item online.

According to an aspect, the account manager 12 may generate at least one of a user identification information field, a card binding information field, and an item use history information field in the database 13. In this case, the account manager 12 may store user identification information in the user identification information field, store default information in the card binding information field, or store default information in the item use history information field.

The account manager 12 may update the user account by storing card binding information in the card binding information field or storing item use history information in the item use history information field, based on the card readout information.

The database 13 stores at least one of the information about the card account and the information about the user account. The database 13 may store information about at least one card account or information about at least one user account under the control of the account manager 12.

According to aspects of the presently disclosed embodiment, only when the card account is generated, the user identification information is bound to the card account, and only one piece of user identification is exclusively bound to one card account, thereby providing the game service with enhanced security.

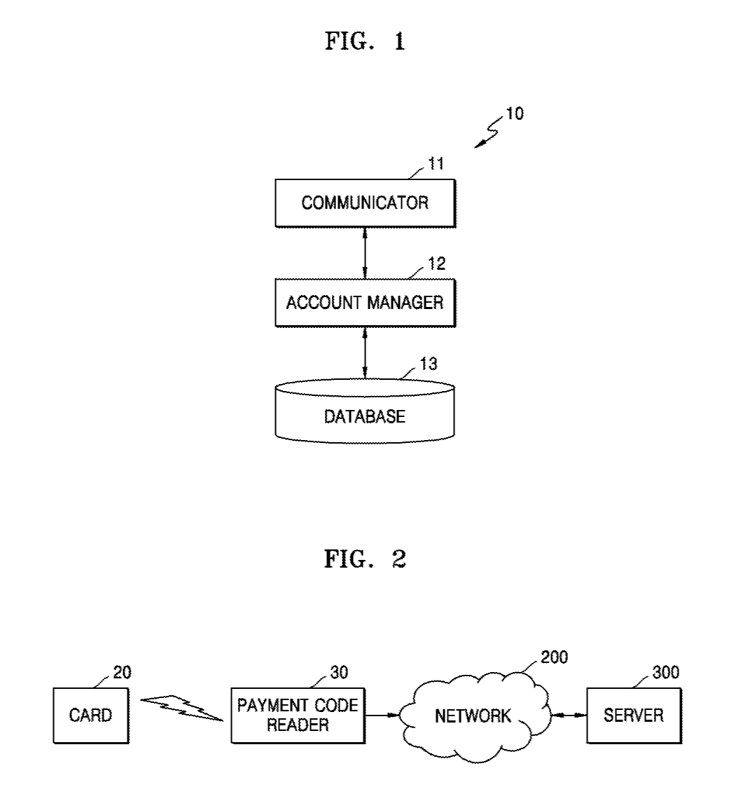

FIG. 2 is a diagram for describing a relationship between a card, a payment code reader, and a game service providing device, according to an aspect of the presently disclosed embodiment.

Referring to FIG. 2, the game service providing device 10 according to the aspect of the presently disclosed embodiment may be implemented in a server 300 and connected to a payment code reader 30 via a network 200 including a wired and/or wireless communication network such as Internet and/or Intranet. That is, the game service providing device 10 may be distinguished from the payment code reader 30 and may be connected to the network 40 in a state of being separated from the payment code reader 30.

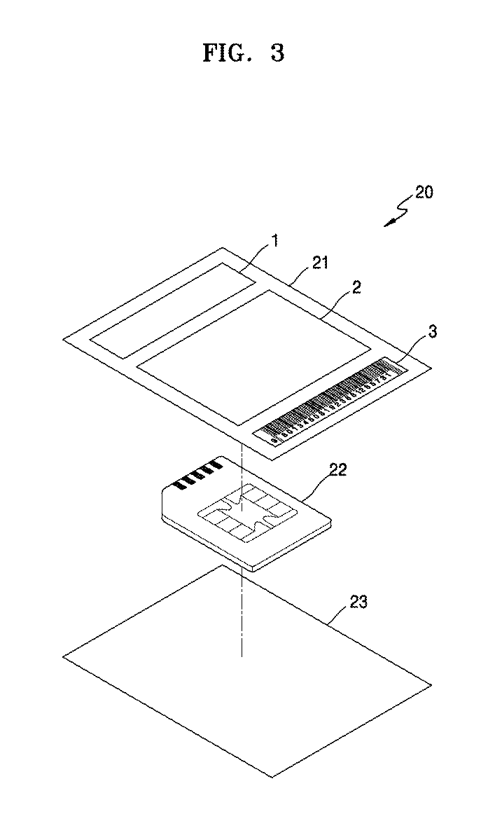

The payment code reader 30 reads a payment code provided in a card 20, and generates payment code readout information including transaction information such as transaction identification information, affiliate code, product information, and transaction amount. Hereinafter, the card 20 read by the payment code reader 30, according to an aspect of the presently disclosed embodiment, will be described in more detail with reference to FIG. 3.

FIG. 3 is a diagram schematically illustrating a configuration of a card according to an aspect of the presently disclosed embodiment.

Referring to FIG. 3, the card 20 includes at least one radio frequency module 22 between two outer covers 21 and 23.

The outer covers 21 and 23 may be papers, plastics, or the like, but are not limited thereto. An item title 1, an item image 2, a payment code 3, and the like may be displayed on the first outer cover 21. The item title 1 may include characters, numbers, symbols, and the like indicating the item or the game service in which the item is used. The item image 2 may include an image of an item displayed on the game service.

The payment code 3 is readable by the payment code reader 30. The payment code 3 may be a two-dimensional code such as a QR code or a barcode, an IC chip, and the like, but is not limited thereto. The payment code reader 30 may read the payment code 3 displayed on the outer covers 21 and 23 of the card 20 and generate payment code readout information of the card 20, or may read a payment code displayed on an outer cover of a card bundle (not illustrated) including the card 20 and generate payment code readout information of the card bundle (not illustrated).

The radio frequency module 22 is readable by a radio frequency reader. The payment code 3 and the radio frequency module 22 may be read by different readers.

The radio frequency module 22 operates in a predetermined radio frequency band. A plurality of radio frequency modules included in a plurality of cards may operate in different radio frequency bands, and the radio frequency reader may simultaneously read the radio frequency modules of the respective cards constituting the card bundle (not illustrated).

The radio frequency module 22 may include objects (for example, characters, items, cash, and the like) available on the game service providing device 10 according to the aspects of the presently disclosed embodiment The following description of the item card can also be equally applied to a character card or a cash card.

According to an aspect of the presently disclosed embodiment, the reading of the radio frequency module 22 by the radio frequency reader is meaningful only in an active mode of the card 20 in which the payment code 3 is read by the payment code reader 30 to generate payment code readout information, and the card account corresponding to the card 20 is generated based on the payment code readout information. In a non-active mode of the card 20 in which the payment code 3 is not read by the payment code reader 30, or the payment, code readout information is not generated, or the card account corresponding to the card 20 is not generated based on the payment code readout information, even if the radio frequency module 22 is read by the radio frequency reader, items cannot be used online based thereon.

That is, the game service providing device 10 according to the aspect of the presently disclosed embodiment may perform control to acquire items available online with respect to only the card 20 that has been purchased.

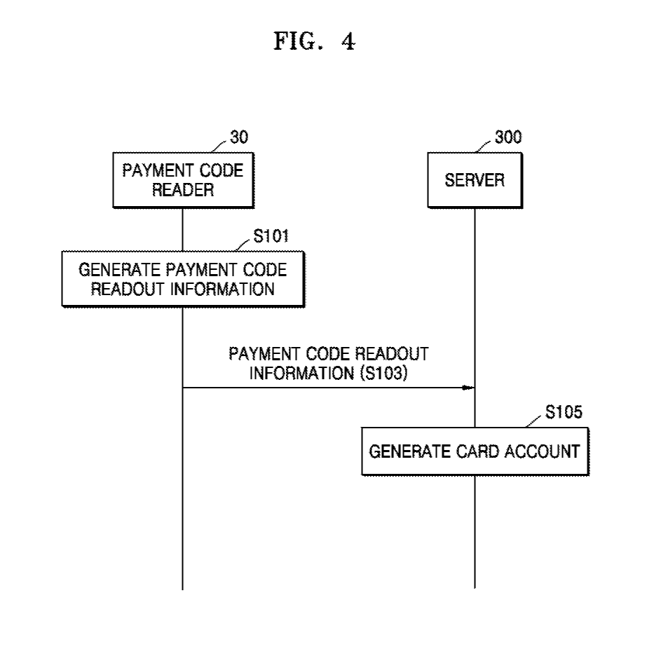

FIG. 4 is a flowchart schematically describing a card activating method for providing a game service, according to another aspect of the presently disclosed embodiment.

Referring to FIG. 4, as described above, the payment code reader 30 reads a payment code provided in the card 20 and generates payment code readout information (S101).

When payment code readout information is received via network 200 (S103), the server 300 in which the game service providing device 10 according to the aspect of the presently disclosed embodiment is implemented generates a card account corresponding to the card 20 based on the payment code readout information (S105).

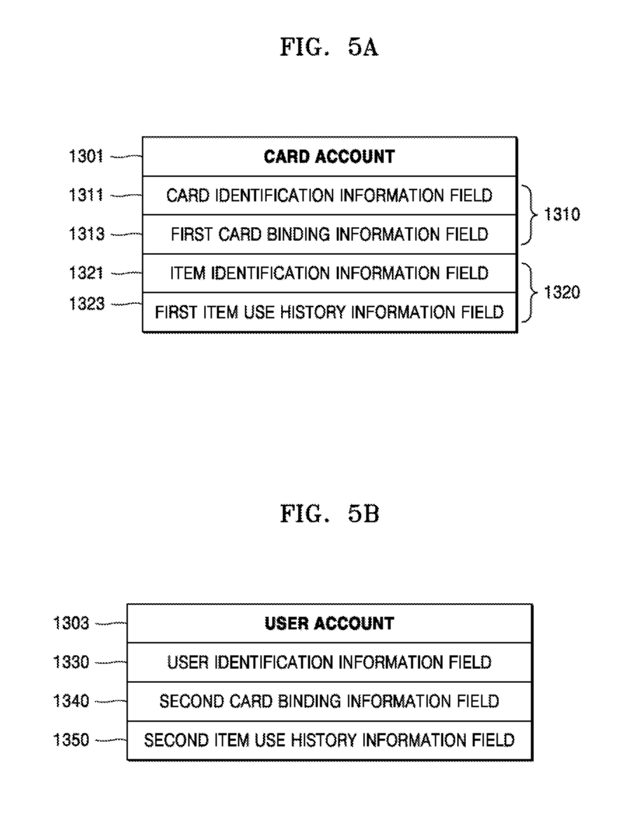

The server 300 may generate the card account corresponding to the card 20 by generating a field storing information about the card account in a storage region. Hereinafter, the field storing the information about the card account will be described in detail with reference to FIG. 5.

FIGS. 5a and 5b are diagrams for describing a card account and a user account generated by a game service providing device, according to an aspect of the presently disclosed embodiment.

When the card account 1301 is generated according to the aspect of the presently disclosed embodiment, at least one of a card information field 1310 and an item information field 1320 of the card account 1301 may be generated in the storage region.

The card information field 1310 may include at least one of a card identification information field 1311 that stores card identification information identifying the item card, and a first card binding information field 1313 that stores first card binding information indicating an owner of the item card.

The item information field 1320 may include at least one of an item identification information field 1321 that stores item identification information identifying the item included in the item card, and a first item use history information field 1323 that stores first item use history information indicating the use history of the item online.

After the card account 1301 is generated, the server 300 may extract information identifying the card 20, for example, a first card number, based on the payment code readout information, or extract information identifying the item included in the card 20, for example, a first item number. The server 300 may store the first card number in the card identification information field 1311, or store the first item number in the item identification information field 1321.

Referring to FIG. 5b, when the user account 1303 is generated according to the aspect of the presently disclosed embodiment, at least one of a user identification information field 1330 that stores user identification information identifying the user, a second card binding information field 1340 that stores second card binding information indicating the item card owned by the user, and a second item use history information field 1350 that stores second item use history information indicating the user's use history of the item online may be generated in the storage region.

As such, according to the aspect of the presently disclosed embodiment, the update of the card account according to aspects of the presently disclosed embodiment is performed in the active mode of the card 20 in which the card account is generated by the server 300, thereby providing the game service with more enhanced security.

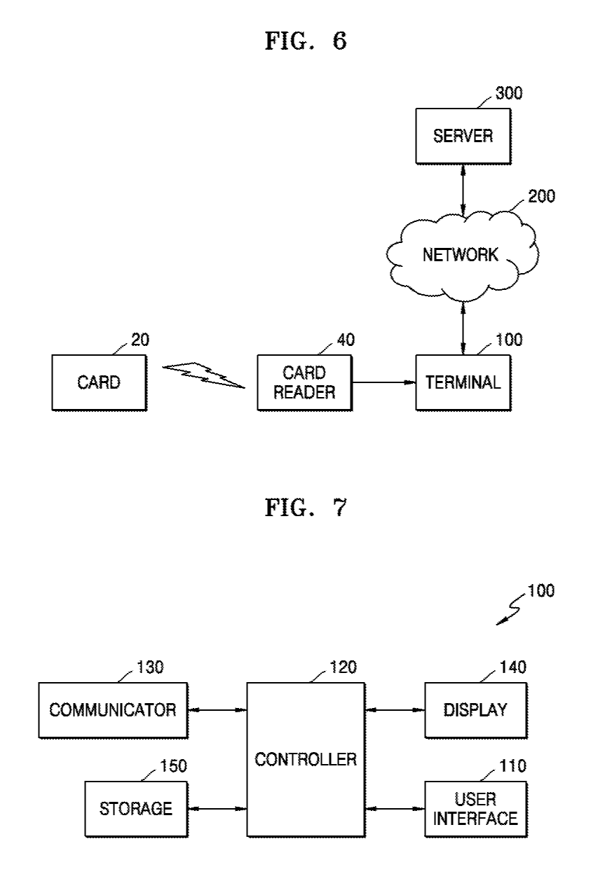

FIG. 6 is a diagram for describing a relationship between a card, a card reader, a terminal, and a game service providing device, according to an aspect of the presently disclosed embodiment.

Referring to FIG. 6, the game service providing device 10 according to the aspect of the presently disclosed embodiment may be implemented in a server 300 and connected to a terminal 100 via a network 200 including a wired and/or wireless communication network such as Internet and/or Intranet. That is, the game service providing device 10 may be distinguished from the terminal 100 and may be connected to the network 200 in a state of being separated from the terminal 100.

Although not illustrated, the game service providing device 10 according to another aspect of the presently disclosed embodiment may be included in the terminal 100. There are various methods of including the game service providing device 10 of the present aspect in the terminal 100. As a specific aspect, each user may install the game service providing device 10 in the terminal 100 via the network 200. For example, the user may install the game service providing device 10 in the terminal 100 in the form of an application. As another specific aspect, the game service providing device 10 may be installed in the terminal 100 via an offline. However, this is merely an example and the presently disclosed embodiment is not limited thereto. The game service providing device 10 may be installed in the terminal 100 in various forms. The terminal 100 may include the game service providing device 10 in a controller 120 illustrated in FIG. 7, and may further include the game service providing device 10 separately from the controller 120.

Although not illustrated, the game service providing device 10 according to another aspect of the presently disclosed embodiment need not be necessarily implemented by a physical device. That is, the game service providing device 10 may be implemented by organically connecting a plurality of physical devices. To this end, some of the elements included in the game service providing device 10 may be implemented or installed with one physical device, and the others thereof may be implemented or installed with another physical device. In this case, another physical device may be implemented as a part of the terminal 100.

According to implementation examples, the elements (units) included in the game service providing device 10 may be disposed in different physical devices in a distributed manner, and the elements disposed in the distributed manner may be organically connected to perform the functions and/or operations defined herein.

The card reader 40 reads a radio frequency module 22 provided in the card 20, and generates card readout information including card information, item information, and user identification information.

The card reader 40 may be a radio frequency reader, and may simultaneously read a plurality of radio frequency modules provided in a plurality of cards and generate a plurality of pieces of card readout information.

The card reader 40 and the terminal 100 may be connected by wire or by wireless. For example, the card reader 40 may include a connector connected to an 8-pin port provided in the terminal 100. Although not illustrated, the card reader 40 may be provided in the terminal 100.

The terminal 100 may transmit information, which is generated by the card reader 40 by reading the card 20, to the server 300 via the network 200, and may receive a game service providing screen such as card account generation notification, item display information, and item deletion display information transmitted from the server 300 via the network 200.

The terminal 100 may be a mobile terminal, such as a notebook, a hand-held device, a smartphone, or a tab, a desktop computer, or any appropriate devices using such devices or directly or indirectly connected thereto. Hereinafter, the terminal 100 according to an aspect of the presently disclosed embodiment will be described in more detail with reference to FIG. 7.

FIG. 7 is a block diagram schematically illustrating a terminal according to an aspect of the presently disclosed embodiment.

Referring to FIG. 7, the terminal 100 includes a user interface 110, a controller 120, a communicator 130, a display 140, and a storage 150.

The user interface 110 may provide an interface with a user for operation control of the terminal 100. The user interface 110 may receive a user operation signal and transmit the received user operation signal to the controller 120. For example, the user interface 110 may receive a user's item execution input and transmit the received item execution input to the controller 120.

The controller 120 performs the function of controlling the overall operation of the terminal 100.

The communicator 130 communicates with the card reader 40 or the server 300. The communicator 130 may receive card readout information from the card reader 40 and transmit the received card readout information to the server 300. The communicator 130 may transmit a user's item execution input received by the user interface 110 to the server 300. The communicator 130 may receive a game service providing screen, card account generation notification, item display information, and item deletion display information from the server 300.

The display 140 may display, on the screen, the game service providing screen, the card account generation notification, the item display information, and the item deletion display information received from the server 300. The display 140 may include at least one of a liquid crystal display (LCD), an organic light-emitting display (OLED), an electrophoretic display (EPD), a flexible display, and a three-dimensional (3D) display. Two or more displays 140 may be provided according to an implementation type of the terminal 100.

The storage 150 may store the card readout information, the game service providing screen, the card account generation notification, the item display information, and the item deletion display information.

The storage 150 may include at least one storage medium selected from among flash memory, hard disk, multimedia card micro type memory, card type memory (e.g., SD or XD memory), random access memory (RAM), and read-only memory (ROM). Also, the storage 150 may include a virtual space of a cloud environment connected by wire and/or by wireless, like a web storage that performs a storing function on the Internet.

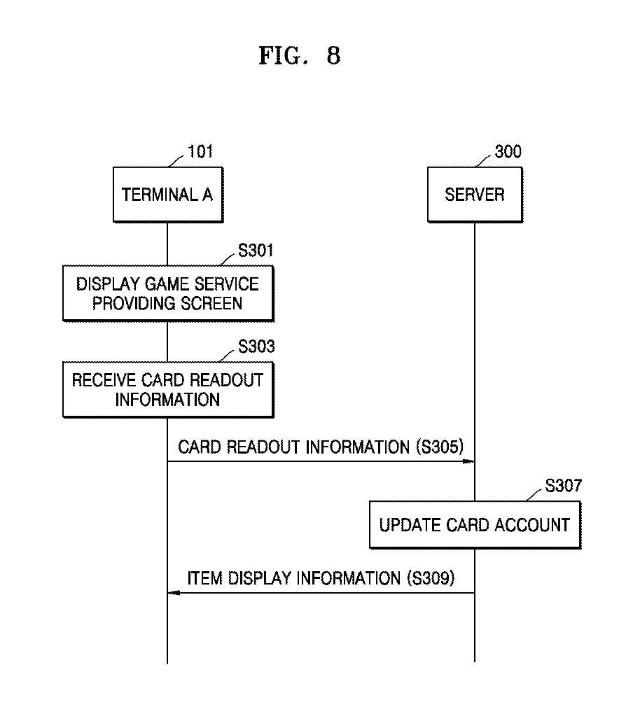

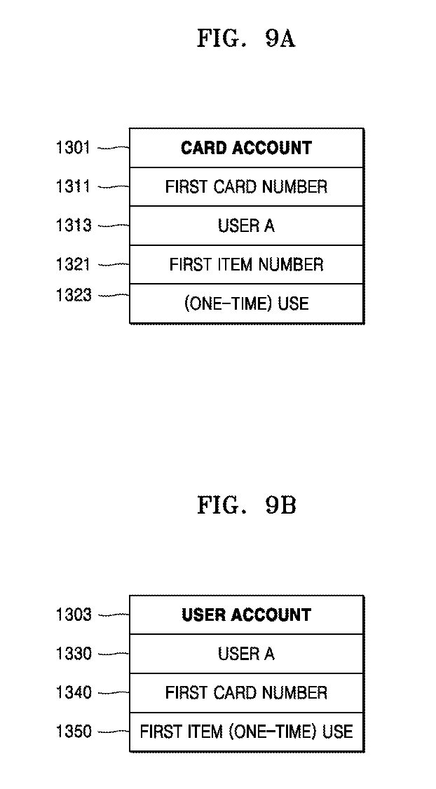

Hereinafter, a game service providing method according to an aspect of the presently disclosed embodiment will be described with reference to FIGS. 8, 9A, and 9B. The following description will be separately given so as to indicate that a terminal A 101 and a terminal B 103 perform the same function as the terminal 100, a user A of the terminal A 101 is different from a user B of the terminal B 103. Hereinafter, the game service providing method, which is performed in an active mode of the card 20, according to aspects of the presently disclosed embodiment will be described in detail. In the active mode, for example, while the card account 1301 for a first card including a first item is generated, a first card number, default information, a first item number, and default information may be prestored in a card identification information field 1311, a first card binding information field 1313, an item identification information field 1321, and a first item use history information field 1323, respectively. The user account 1303 may be generated not only in an active mode but also in an inactive mode. User A identification information may be prestored in a user identification information field 1330.

FIG. 8 is a flowchart schematically describing a game service providing method according to an aspect of the presently disclosed embodiment.

Referring to FIG. 8, a game service providing screen is displayed on the terminal A101 (S301). When a user input for receiving the game service is received, or when an operation in which the card reader 40 is connected to the terminal A 101 is detected, the terminal A 101 may display the game service providing screen, but is not limited thereto.

Then, the terminal A 101 receives card readout information from the card reader 40 (S303) and transmit the received card readout information to the server 300 (S305).

As illustrated in FIG. 9a, the server 300 updates the card account 1301 based on the card readout information received from the terminal A 101 (S307).

FIGS. 9a and 9b are diagrams for describing a card account and a user account updated by a game service providing device, according to an aspect of the presently disclosed embodiment.

Referring to FIG. 9a, the server 300 may update at least one of the first card binding information field 1313 and the first item use history information field 1323 of the card account 1301, based on the card readout information. The server 300 may store user A identification information, which is included in the card readout information received from the terminal A 101, in the first card binding information field 1313, or store first item one-time use information in the first item use history information field 1323.

Referring to FIG. 9b, the server 300 may update at least one of the second card binding information field 1340 and the second item use history information field 1350 of the user account 1303, based on the card readout information. The server 300 may detect the user account 1303 in which the same user identification information as the user A identification information included in the card readout information received from the terminal A 101 is stored in the user identification information field 1330, and store the first card number included in the card readout information received from the terminal A 101 in the second card binding information field 1340, or store the first item one-time use information in the second item use history information field 1350.

Referring to FIG. 8 again, when the first item one-time use information is stored in the first item use history field 1323, the server 300 transmits the first item display information to the terminal A 101 (S309).

Accordingly, since the terminal A 101 reads the card 20 through the card reader 40, the game service providing screen on which the item included in the card 20 is displayed can be received from the server 300.

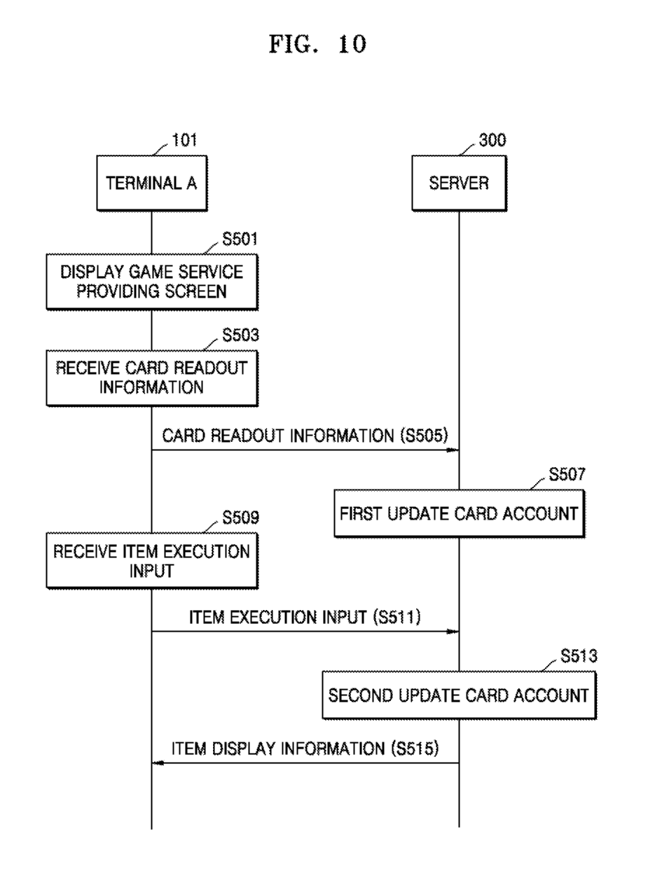

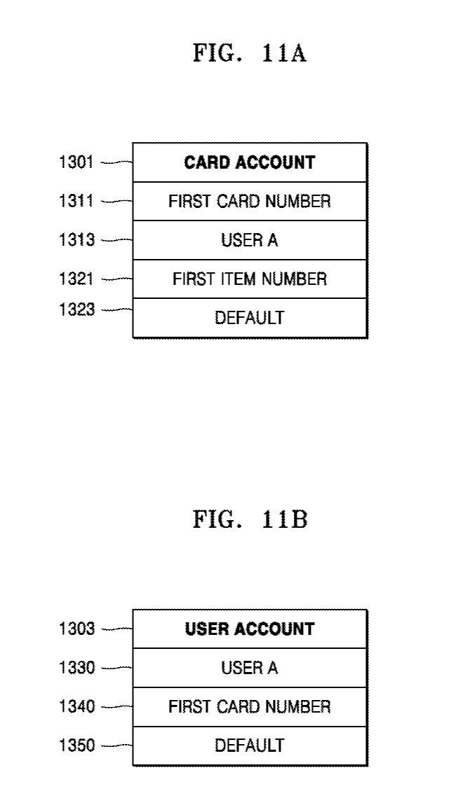

Hereinafter, a game service providing method according to another aspect of the presently disclosed embodiment will be described with reference to FIGS. 10, 11a, and 11b.

FIG. 10 is a flowchart schematically describing a game service providing method according to another aspect of the presently disclosed embodiment.

Referring to FIG. 10, a game service providing screen is displayed on the terminal A 101 (S501).

Then, the terminal A 101 receives card readout information from the card reader 40 (S503) and transmit the received card readout information to the server 300 (S505).

As illustrated in FIG. 11a, the server 300 updates the card account 1301 based on the card readout information received from the terminal A 101 (S507).

FIGS. 11a and 11b are diagrams for describing a card account and a user account updated by a game service providing device, according to another aspect of the presently disclosed embodiment.

Referring to FIG. 11a, the server 300 may update a first card binding information field 1313 of a card account 1301, based on card readout information. The server 300 may store user A identification information, which is included in the card readout information received from the terminal A 101, in the first card binding information field 1313.

Referring to FIG. 11b, the server 300 may update a second card binding information field 1340 of the user account 1303, based on card readout information. The server 300 may detect the user account 1303 in which the same user identification information as the user A identification information included in the card readout information received from the terminal A 101 is stored in the user identification information field 1330, and store a first card number included in the card readout information received from the terminal A 101 in the second card binding information field 1340.

Referring to FIG. 10 again, the terminal A 101 receives an item execution input through the user interface 110 (S509), and transmits the received item execution input to the server 300 (S511).

As illustrated in FIG. 9a, the server 300 updates the card account 1301 based on the item execution input received from the terminal A 101 (S513).

Referring to FIG. 9a again, the server 300 may update a first item use history information field 1323 of the card account 1301, based on the item execution input. The server 300 may store first item one-time use information, which is included in the item execution input received from the terminal A 101, in the first item use history information field 1323.

Referring to FIG. 9b again, the server 300 may update a second item use history information field 1350 of the user account 1303, based on the item execution input. The server 300 may detect the user account 1303 in which the same user identification information as the user A identification information included in the item execution input received from the terminal A 101 is stored in the user identification information field 1330, and store first item one-time use information included in the item execution input received from the terminal A 101 in the second item use history information field 1350.

Referring to FIG. 10 again, when the first item one-time use information is stored in the first item use history field 1323, the server 300 transmits the first item display information to the terminal A 101 (S515).

Accordingly, after the terminal A 101 reads the card 20 through the card reader 40, the terminal A 101 receives, from the user, the item execution input for the item included in the card 20, and thus, the game service providing screen on which the item included in the card 20 is displayed can be received from the server 300.

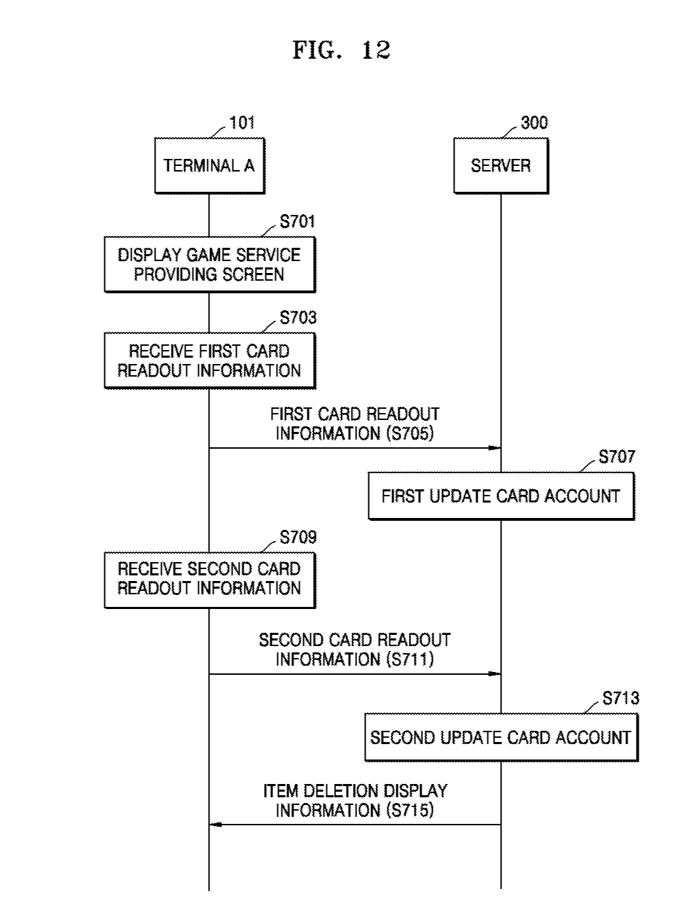

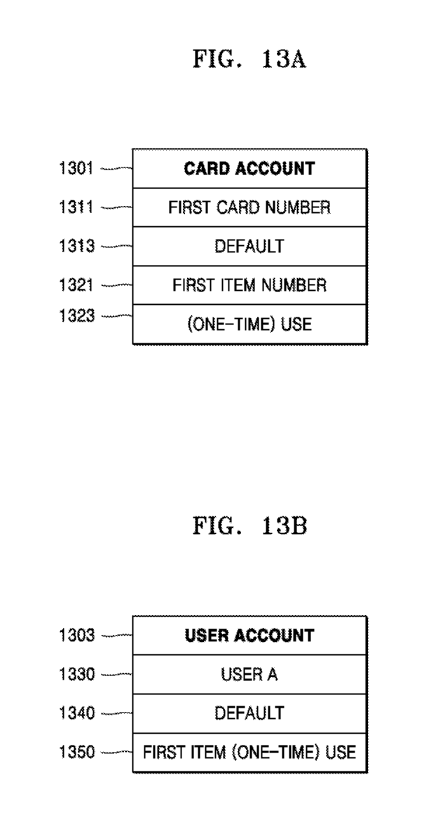

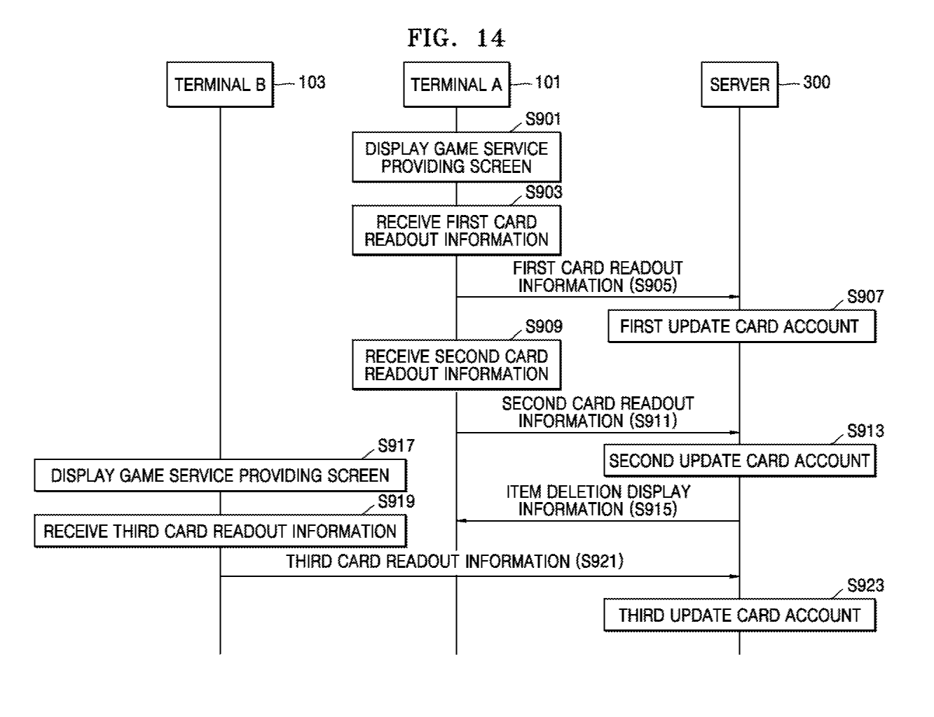

Hereinafter, a game service providing method according to another aspect of the presently disclosed embodiment will be described with reference to FIGS. 12, 13a, and 13b.

FIG. 12 is a flowchart schematically describing a game service providing method according to another aspect of the presently disclosed embodiment.

The following description will be given on the assumption that a result of performing operations S701 to S707 in FIG. 12 is the same as a result of performing operations S301 to S307 in FIG. 8.

Referring to FIG. 12, a game service providing screen is displayed on the terminal A 101 (S701). Then, the terminal A 101 receives first card readout information from the card reader 40 (S703) and transmit the received first card readout information to the server 300 (S705). As illustrated in FIG. 9a, the server 300 updates the card account 1301 based on the first card readout information received from the terminal A 101 (S707).

Then, the terminal A 101 receives second card readout information from the card reader 40 (S709) and transmit the received second card readout information to the server 300 (S711). In this case, the second card readout information includes the same information as the first card readout information.

As illustrated in FIG. 13a, the server 300 updates the card account 1301 based on the second card readout information received from the terminal A 101 (S713).

FIGS. 13a and 13b are diagrams for describing a card account and a user account updated by a game service providing device, according to another aspect of the presently disclosed embodiment.

Referring to FIG. 13a, the server 300 may update a first card binding information field 1313 of a card account 1301, based on second card readout information. When the same information as the user A identification information included in the second card readout information received from the terminal A 101 is prestored in the first card binding information field 1313, the server 300 may delete the user A identification information from the first card binding information field 1313, based on the second card readout information. As a result of deleting the user A identification information, default information may be stored in the first card binding information field 1313. In this case, the server 300 may not store the first item one-time use information in the first item use history information field 1323.

Referring to FIG. 13b, the server 300 may update a second card binding information field 1340 of a user account 1303, based on second card readout information. The server 300 may detect the user account 1303 in which the same user identification information as the user A identification information included in the second card readout information received from the terminal A 101 is stored in the user identification information field 1330, and delete a first card number from the second card binding information field 1340 based on the second card readout information when the same information as the first card number included in the second card readout information received from the terminal A 101 is prestored in the second card binding information field 1340. In this case, the server 300 may not store the first item one-time use information in the second item use history information field 1350.

Referring to FIG. 12 again, for example, when the user A identification information is deleted from the first card binding information field 1313, the server 300 transmits the first item deletion display information to the terminal A 101 (S715).

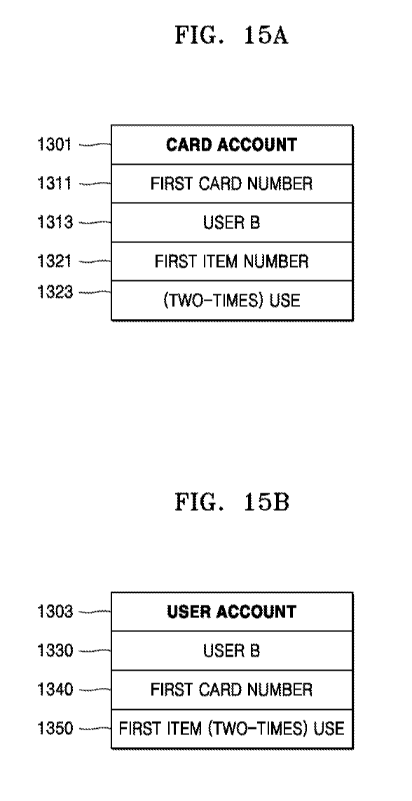

Hereinafter, a game service providing method according to another aspect of the presently disclosed embodiment will be described with reference to FIGS. 14, 15a, and 15b.

FIG. 14 is a flowchart schematically describing a game service providing method according to another aspect of the presently disclosed embodiment.

The following description will foe given on the assumption that a result of performing operations S901 to S915 in FIG. 14 is the same as a result of performing operations S701 to S715 in FIG. 12.

Referring to FIG. 14, a game service providing screen is displayed on the terminal A 101 (S901). Then, the terminal A 101 receives first card readout information from the card reader 40 (S303) and transmit the received first card readout information to the server 300 (S905). As illustrated in FIG. 9a, the server 300 updates the card account 1301 based on the first card readout information received from the terminal A 101 (S907).

Then, the terminal A 101 receives second card readout information from the card reader 40 (S909) and transmit the received second card readout information to the server 300 (S911). In this case, the second card readout information includes the same information as the first card readout information. As illustrated in FIG. 13a, the server 300 updates the card account 1301 based on the second card readout information received from the terminal A 101 (S913). For example, when the user A identification information is deleted from the first card binding information field 1313, the server 300 transmits the first item deletion display information to the terminal A 101 (S915).

A terminal B 103 displays a game service providing screen (S917). Then, the terminal B 103 receives third card readout information from the card reader 40 (S919) and transmit the received third card readout information to the server 300 (S921). In this case, the third card readout information has the same card information as the first card readout information, but has different user identification information from the first card readout information. As illustrated in FIG. 15a, the server 300 updates the card account 1301 based on the third card readout information received from the terminal B 103 (S923).

FIGS. 15a and 15b are diagrams for describing a card account and a user account updated by a game service providing device, according to another aspect of the presently disclosed embodiment.

Referring to FIG. 15a, the server 300 may update at least one of the first card binding information field 1313 and the first item use history information field 1323 of the card account 1301, based on the third card readout information. The server 300 may store user B identification information, which is included in the third card readout information received from the terminal B 103, in the first card binding information field 1313, or store first item two-times use information in the first item use history information field 1323.

Referring to FIG. 15b, the server 300 may update at least one of the second card binding information field 1340 and the second item use history information field 1350 of the user account 1303, based on the third card readout information. The server 300 may detect the user account 1303 in which the same user identification information as the user B identification information included in the third card readout information received from the terminal B 103 is stored in the user identification information field 1330, and store the first card number included in the third card readout information received from the terminal B 103 in the second card binding information field 1340, or store the first item two-times use information in the second item use history information field 1350.

The game service providing methods according to aspects of the presently disclosed embodiment may be embodied as computer-readable codes on a non-transitory computer-readable recording medium. The computer-readable recording medium may be any recording medium that can store data which is thereafter readable by a computer system. Examples of the computer-readable recording medium include ROM, RAM, CD-ROMs, magnetic tapes, floppy disks, and optical data storage devices. The computer-readable recording medium may also be distributed over network-coupled computer systems so that the computer-readable code is stored and executed by at least one processor in a distributed fashion. Also, functional programs, codes, and code segments for implementing the presently disclosed embodiment may be easily construed by programmers skilled in the art to which the presently disclosed embodiment pertains.

While the technical spirit of the presently disclosed embodiment has been described with reference to aspects, it will be understood by those of ordinary skill in the art that various modifications and changes can be made thereto without departing from the scope of the presently disclosed embodiment. Therefore, the aspects disclosed in the presently disclosed embodiment are not intended to limit the scope of the presently disclosed embodiment, but are intended to describe the presently disclosed embodiment. The scope of the technical idea of the presently disclosed embodiment is not limited by these aspects. The scope of the protection of the presently disclosed embodiment should be construed by the appended claims. All technical ideas within the scope of equivalents thereof should be construed as falling within the scope of the presently disclosed embodiment.

What is claimed is:

1. A game service providing device comprising:
a communicator that receives at least one of first card readout information, which includes at least one of payment code readout information including card identification information identifying an item card, the card identification information, and first user identification information, and second card readout information, which includes at least one of the card identification information and the first user identification information;
a database that includes at least one of a card identification information field that stores the card identification information, and a first card binding information field that stores first card binding information indicating an owner of the item card; and
an account manager that generates a card account corresponding to the item card based on the payment code readout information, stores the card identification information in the card identification information field or stores default information in the first card binding information field, stores the first user identification information in the first card binding information field based on the first card readout information, and deletes the first user identification information from the first card binding information field based on the second card readout information.

2. The game service providing device of claim 1, wherein the communicator receives payment code readout information of an item card bundle including the item card,
the account manager generates a plurality of card accounts corresponding to a plurality of item cards included in the item card bundle based on the payment code readout information, and
the database stores information about each of the plurality of card accounts.

3. The game service providing device of claim 2, wherein the item card comprises a radio frequency module operating in a predetermined radio frequency band, and
a plurality of radio frequency modules included in the plurality of item cards operate in different radio frequency bands.

4. The game service providing device of claim 1, wherein the communicator receives third card readout information including at least one of the card identification information and second user identification information that is different from the first user identification information,
when the first user identification information is stored in the first card binding information field based on the first card readout information, the account manager is maintained such that the first user identification information is stored in the first card binding information field even though the second user identification information has been received, and
when the first user identification information is deleted from the first card binding information field based on the second card readout information, the account manager stores the second user identification information in the first card binding information based on the third card readout information.

5. The game service providing device of claim 1, wherein the database include at least one of an item identification information field that stores item identification information identifying an item included in the item card, and a first item use history information field that stores first item use history information indicating a use history of the item online.

6. The game service providing device of claim 5, wherein the communicator receives an item execution input for using the item included in the item card online,
the first card readout information includes the item identification information, and
the account manager stores the item identification information in the item identification information field based on the first card readout information, stores default information or item one-time use information in the first item use history information field based on the first card readout information, or stores the item one-time use information in the first item use history information field based on the item execution input.

7. The game service providing device of claim 1, wherein the account manager generates a user account corresponding to a user receiving a game service, and updates the user account based on the first card readout information,
the database stores information about the user account, and
the information about the user account is stored in a user identification information field that stores user identification information identifying the user, a second card binding information field that stores second card binding information indicating an item card owned by the user, and a second item use history information field that stores second item use history information indicating a user's use history of the item online.

8. A game service providing method comprising:
receiving, by a communicator, payment code readout information including card identification information identifying an item card;
generating, by an account, manager, at least one of card identification information field and a first card binding information field in a database based on the payment code readout information to generate a card account corresponding to the item card;
storing, by the account manager, the card identification information in the card identification information field or storing default information in the first card binding information field;
receiving, by the communicator, first card readout, information including at least one of the card identification information and first user identification information;
storing, by the account manager, the first user identification information in the first, card binding information field based on the first card readout information;
receiving, by the communicator, second card readout information including at least one of the card identification information and the first user identification information; and
deleting, by the account manager, the first user identification information from the first card binding information field based on the second card readout information.

9. The game service providing method of claim 8, further comprising:
receiving, by the communicator, third card readout information including at least one of the card identification information and second user identification information that is different from the first user identification information, and
when the first user identification information is stored in the first card binding information field based on the first card readout information, maintaining the account manager such that the first user identification information is stored in the first card binding information field even though the second user identification information has been received, and
when the first user identification information is deleted from the first card binding information field based on the second card readout information, storing the second user identification information in the first card binding information based on the third card readout information.

10. A computer program recorded on a medium, which, when executed by a computer, performs the method of claim 8.
